(19) United States
(12) Patent Application Publication
(10) Pub. No.: US 2025/0136024 A1
(43) Pub. Date: May 1, 2025

(54) WIRE HARNESS

(71) Applicant: YAZAKI CORPORATION, Tokyo (JP)

(72) Inventors: Mitsuhisa Sano, Makinohara-shi (JP); Terumitsu Sugimoto, Makinohara-shi (JP)

(21) Appl. No.: 19/008,602

(22) Filed: Jan. 2, 2025

Related U.S. Application Data
(63) Continuation of application No. PCT/JP2023/038319, filed on Oct. 24, 2023.

(30) Foreign Application Priority Data
Nov. 29, 2022 (JP) 2022-190172

(51) Int. Cl. B60R 16/02; H02G 3/30

(52) U.S. Cl. CPC B60R 16/0215; H02G 3/30

(57) ABSTRACT

A wire harness includes: a trunk line module that includes a flexible printed circuit board exhibiting flexibility and a plurality of trunk line side connectors provided at an end part of the flexible printed circuit board; and a plurality of branch line modules each including a plurality of routing materials exhibiting conductivity, and a branch line side first connector that is provided at terminals on one side of the routing materials, and mechanically and electrically connected to the trunk line side connector. The flexible printed circuit board includes a wiring pattern that includes: a plurality of conductor circuit parts that configure a transmission path by being electrically connected to each of the routing materials via the trunk line side connector and the branch line side first connector; and a joint part that mutually connects at least two of the conductor circuit parts.

### CROSS-REFERENCE TO RELATED APPLICATION(S)

This application is a continuation application of International Application No. PCT/JP2023/038319 filed on Oct. 24, 2023 which claims the benefit of priority from Japanese Patent Application No. 2022-190172 filed on Nov. 29, 2022 and designating the U.S., the entire contents of which are incorporated herein by reference.

### BACKGROUND OF THE INVENTION

### 1. Field of the Invention

The present invention relates to a wire harness.

### 2. Description of the Related Art

As a conventional technology related to wire harnesses, for example, JP 2007-150 047 A discloses a wire harness provided with a trunk line module that includes a flexible printed circuit board exhibiting flexibility and a plurality of trunk line side connectors provided on an end part of the flexible printed circuit board.

By the way, as for the wire harnesses described in JP 2007-150 047 A mentioned above, there is room for further improvement in terms of assemblability to vehicles and the like, for example.

### SUMMARY OF THE INVENTION

The present invention is designed in view of the aforementioned circumstances, and it is an object thereof to provide a wire harness that can improve the assemblability to vehicles and the like.

In order to achieve the above mentioned object, a wire harness according to one aspect of the present invention includes a trunk line module that includes a flexible printed circuit board exhibiting flexibility and a plurality of trunk line side connectors provided at an end part of the flexible printed circuit board; and a plurality of branch line modules each including a plurality of routing materials exhibiting conductivity, and a branch line side first connector that is provided at terminals on one side of the routing materials, and mechanically and electrically connected to the trunk line side connector, wherein the flexible printed circuit board includes a wiring pattern that includes: a plurality of conductor circuit parts that configure a transmission path by being electrically connected to each of the routing materials via the trunk line side connector and the branch line side first connector; and a joint part that mutually connects at least two of the conductor circuit parts, wherein in each of the branch line modules, all of the routing materials configuring the branch line module extend without a branching point from the branch line side first connector provided at the terminals on one side to a branch line side second connector provided at terminals on other side, wherein a plurality of the joint parts are provided in the wiring pattern, and the entire branching points including the trunk line module and the branch line modules are concentrated in the joint parts.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a vehicle to which a wire harness according to an embodiment is applied;

FIG. 2 is an exemplary schematic plan view of the wire harness according to the embodiment;

FIG. 3 is an exemplary schematic plan view of part of a flexible printed circuit board of the wire harness according to the embodiment; and

FIG. 4 is an exemplary schematic plan view of a branch line module of the wire harness according to the embodiment.

### DETAILED DESCRIPTION OF THE PREFERRED EMBODIMENTS

Hereinafter, an embodiment according to the present invention will be described in detail with reference to the accompanying drawings. It is to be noted that the present invention is not limited by the embodiment. Furthermore, the structural components in the following embodiment include those that are easily replaceable by those skilled in the art, or those that are substantially the same. In this specification, ordinal numbers are used only to distinguish components, members, parts, positions, directions, and the like, and do not indicate the order or priority.

### Embodiment

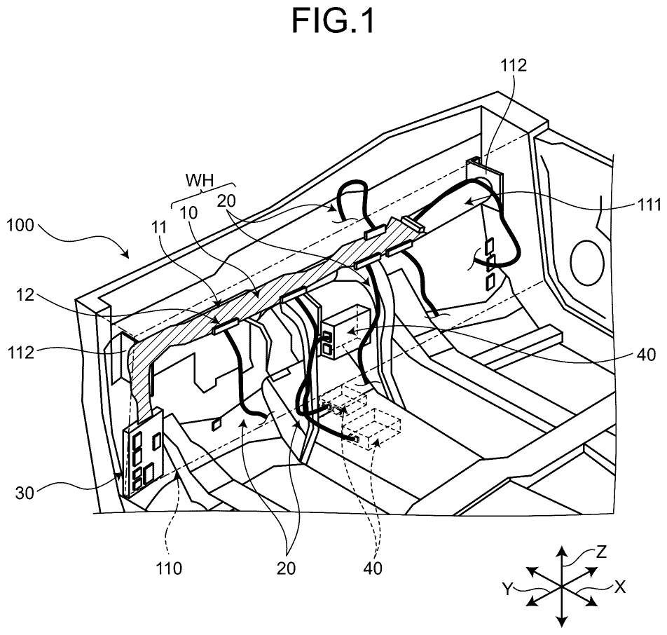

FIG. 1 is a perspective view of a vehicle 100 to which a wire harness WH according to an embodiment is applied. The wire harness WH according to the present embodiment illustrated in FIG. 1 is applied to the vehicle 100 and used for power supply and signal communication by connecting each of devices loaded on the vehicle 100. The wire harness WH according to the present embodiment is attached to a structural member 111 that is installed inside an instrument panel 110 of the vehicle 100. The instrument panel 110 is an interior panel placed in the front side inside the vehicle along a vehicle width direction Y to face the driver and passenger seats of the vehicle 100. In FIG. 1, the instrument panel 110 is illustrated with a dashed double-dotted line. The structural member 111 is, for example, a reinforcement (reinforcing member) that is configured with a metal hollow pipe and extends along the vehicle width direction Y. A flange 112 is joined to each of both ends of the structural member 111. One of the flanges 112 is fixed to the left side of the body of the vehicle 100, and the other flange 112 is fixed to the right side of the body of the vehicle 100.

In the following description, in regards to a first direction, a second direction, and a third direction intersecting with each other, the first direction is referred to as a “vehicle front-and-rear direction X”, the second direction as the “vehicle width direction Y”, and the third direction as a “vehicle height direction Z”. Herein, the vehicle front-and-rear direction X, the vehicle width direction Y, and the vehicle height direction Z are substantially orthogonal to each other. The vehicle front-and-rear direction X typically corresponds to the direction of the overall length of the vehicle 100 and, more specifically, corresponds to the direction along the front-and-rear straight direction of the vehicle 100. The vehicle width direction Y typically corresponds to the direction of the full width of the vehicle 100, and corresponds to the vehicle left and right directions of the vehicle 100. The vehicle height direction Z typically corresponds to the direction of the height of the vehicle 100. Furthermore, unless otherwise noted, each of the directions used in the following description is described as the direction in a state where the wire harness WH is assembled to the vehicle 100.

The wire harness WH includes, for example, a trunk line module 10 and a plurality of branch line modules 20. The trunk line module 10 is an instrument panel internal structure module that is placed inside the instrument panel 110 of the vehicle 100, more specifically, along the vehicle width direction Y on the structural member 111. The trunk line module 10 is configured with a flexible printed circuit board 11 (flexible printed circuits) and a plurality of trunk line side connectors 12 provided on an end part of the flexible printed circuit board 11. Here, the trunk line module 10 is connected to an ECU 30 via any one of the trunk line side connectors 12, and connected to the branch line modules 20 via the other trunk line side connectors 12. In FIG. 1, hatching is applied on the flexible printed circuit board 11 for convenience. The ECU 30 herein is typically, but not limited to, a zone ECU that comprehensively controls the devices in the peripheral area (zone) of the instrument panel 110.

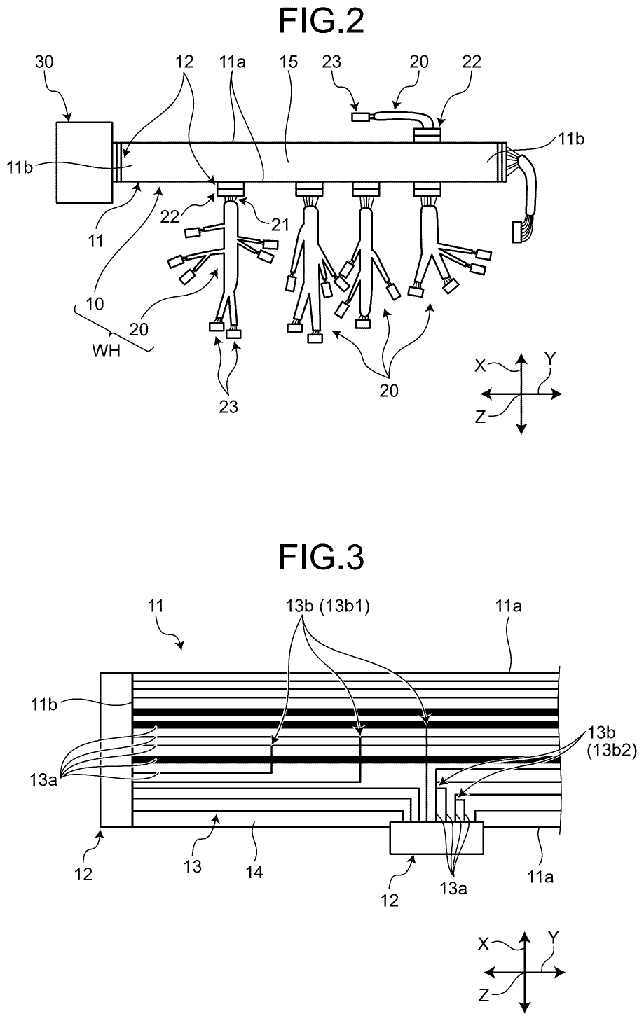

Each of the branch line modules 20 is a wiring module, one end of which is connected to the trunk line side connector 12 of the trunk line module 10 and the other end is connected to various electronic devices 40 in the vehicle 100. The wire harness WH herein has six branch line modules 20. Each of the branch line modules 20 is configured including a plurality of routing materials 21 exhibiting conductivity (see FIG. 2), a branch line side first connector 22 that is provided at terminals on one side of the routing materials 21 and mechanically and electrically connected to each of the trunk line side connectors 12, and a branch line side second connector 23 that is provided at the terminals on the other side of the routing materials 21 and mechanically and electrically connected to various electronic devices 40 in the vehicle 100. The routing material 21 is, for example, an electric wire including a conductor part formed with a plurality of stranded linear metal wires and an insulating sheath part that covers the outside of the conductor part.

FIG. 2 is a schematic plan view of the wire harness WH, and FIG. 3 is a schematic plan view illustrating part of the flexible printed circuit board 11. As illustrated in FIGS. 2 and 3, the flexible printed circuit board 11 is a thin and flexible printed circuit board that is configured including a wiring pattern 13, a base film 14, and a coverlay 15, for example. The base film 14 is a base material that has excellent flexibility and defines the overall shape of the flexible printed circuit board 11. The base film 14 is formed, for example, with a polyimide resin or the like exhibiting excellent heat resistance. The wiring pattern 13 is laminated on the surface (mounting face) of the base film 14 and forms a plurality of conductor circuit parts 13a (pattern layer). The wiring pattern 13 is formed with a conductive material such as copper foil, for example, and it is printed as a printed circuit body on the surface of the base film 14. The coverlay 15 is laminated on the entire surface of the base film 14, that is, on the base film 14 or the wiring pattern 13 via an adhesive, not illustrated, and functions as a protective layer for protecting the conductor circuit parts 13a and the like of the wiring pattern 13.

The flexible printed circuit board 11 as a whole is formed in a rectangular shape that is elongated in the vehicle width direction Y. In other words, the flexible printed circuit board 11 includes a pair of first end parts 11a as the long sides and a pair of second end parts 11b as the short sides. The first end parts 11a are the end parts on both sides of the flexible printed circuit board 11 in the vehicle front-and-rear direction X, and the second end parts 11b are the end parts on both sides of the flexible printed circuit board 11 in the vehicle width direction Y. In the present embodiment, one or more of the trunk line side connectors 12 are placed on each of the first end parts 11a and second end parts 11b of the flexible printed circuit board 11.

Specifically, the trunk line module 10 has seven trunk line side connectors 12, for example. Furthermore, here, four trunk line side connectors 12 are provided on one of the pair of first end parts 11a with a space provided therebetween in the vehicle width direction Y, and one trunk line side connector 12 is provided on the other. Also, one of the trunk line side connectors 12 is provided on one of the pair of second end parts 11b, and one trunk line side connector 12 is provided on the other. Six of the trunk line side connectors 12 are connected to the branch line modules 20 via the branch line side first connectors 22 described above, and the remaining one is connected to the ECU 30 via an ECU side connector. Specifications such as the number of poles of the trunk line side connectors 12, the arrangement of the trunk line side connectors 12 on the flexible printed circuit board 11, and the like can be changed as appropriate in accordance with the installation position of the wire harness WH in the vehicle 100 and the like.

The trunk line side connectors 12 are electrically conductive to the wiring pattern 13 of the flexible printed circuit board 11. The conductor circuit parts 13a configured with the wiring pattern 13 can function as any of circuits such as a signal circuit, a signal GND circuit, and a power ground circuit, for example. The signal circuit is, for example, a circuit that transmits communication signals between the ECU 30 and in-vehicle devices such as various electronic devices 40 in the vehicle 100. The signal GND circuit is a circuit that accompanies the signal circuit and electrically conducts between in-vehicle devices to align the potential to be the reference for the circuit operation between such in-vehicle devices. The power ground circuit is a circuit for grounding the power system of the in-vehicle devices.

Here, in the present embodiment, the wiring pattern 13 has a joint part 13b that mutually connects at least two of the conductor circuit parts 13a. The joint part 13b is, for example, formed simultaneously with the conductor circuit parts 13a at the time of printing the wiring pattern 13, and mutually connects between the signal circuits, the signal GND circuits, the power ground circuits, and the like. The joint part 13b mutually connects at least two conductor circuit parts 13a that are located on the same layer among a plurality of pattern layers configuring the wiring pattern 13. In the present embodiment, a plurality of the joint parts 13b are provided in the wiring pattern 13, and the branching points in the entire wire harness WH are concentrated in the joint parts 13b on the flexible printed circuit board 11. That is, the joint parts 13b includes a joint part 13b1 having a joint function that can be provided on the ECU 30 side, and a joint part 13b2 having a joint function that can be provided on the branch line module 20 side.

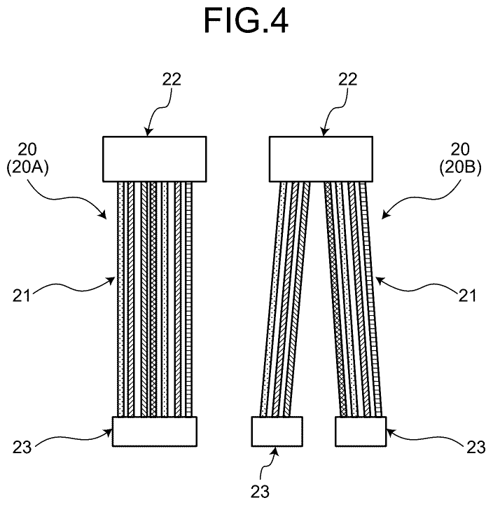

FIG. 4 is a schematic plan view of the branch line modules 20. As illustrated in FIG. 4, the branch line modules 20 include, for example, a first branch line module 20A of type I, a second branch line module 20B of type V, and the like. The first branch line module 20A is a branch line module 20 configured in a one-to-one relationship where the number of the branch line side first connectors 22 provided at the terminals on one side of the routing materials 21 and the number of the branch line side second connectors 23 provided at the terminals on the other side of the routing materials 21 are the same. In the meantime, the second branch line module 20B is a branch line module 20 configured in a one-to-many relationship where there are a plurality of the branch line side second connectors 23 with respect to the branch line side first connector 22. The second branch line module 20B herein has the two branch line side second connectors 23. Note that the number of branch line side second connectors 23 of the second branch line module 20B is not limited to such an example, and there may also be three or more of those.

Such first branch line module 20A and second branch line module 20B are branch line modules 20 that can be manufactured by automation. In other words, as for the first branch line module 20A, all of the routing materials 21 configuring the first branch line module 20A extend without branching points (joint parts) from the branch line side first connector 22 provided at the terminals on one side to the branch line side second connector 23 provided at the terminals on the other side. Similarly, as for the second branch line module 20B, all of the routing materials 21 configuring the second branch line module 20B extend without branching points (joint parts) from the branch line side first connector 22 to the two branch line side second connectors 23. Therefore, the configuration on the branch line module 20 side can be simplified compared to the case with the joint part provided in the branch line module 20, thereby making it possible to improve the assemblability to the vehicle 100 and the like.

Furthermore, in the present embodiment, the joint part 13b is provided in the flexible printed circuit board 11, which also has an advantage that the configuration on the ECU 30 side can be more simplified. Specifically, when the ECU 30 has a joint function, there are many circuits in the ECU 30, which may increase the number of poles (wiring connectors) in the ECU 30 and the trunk line side connectors 12, and may increase the product number of the ECU 30. In this respect, according to the present embodiment, the joint part 13b is provided on the trunk line module 10 side, so that the configuration on the ECU 30 side can be more simplified. This makes it possible to reduce the number of poles (wiring connectors) in the ECU 30 and the trunk line side connectors 12 and to reduce the product number of the ECU 30.

Furthermore, in the present embodiment, the trunk line module 10 of the wire harness WH is configured not with electric wires but with the flexible printed circuit board 11. Therefore, the trunk line module 10 configured with the flexible printed circuit board 11 is formed lighter in weight compared to a typical trunk line formed with a bundle of various types of electric wires. Here, when the aforementioned wire harness WH is installed inside the vehicle 100, it is assumed that the length of the trunk line module 10 may extend to be about 1000 mm. If all trunk lines of such a length are configured with electric wires, the weight of the trunk line itself, and thus the weight of entire wire harness WH, may increase. In this respect, according to the present embodiment, since the trunk line module 10 is configured with the flexible printed circuit board 11, it is possible to correspond to the increase in size of the wire harness WH while suppressing increase in the weight of the trunk line module 10 or in the overall weight of the wire harness WH.

When the wire harness WH is set up in the instrument panel 110 of the vehicle 100, it includes many branch line modules 20 corresponding to various devices such as a meter, air conditioner, audio equipment, and the like. Therefore, it is heavier than the wire harness WH that is attached to other part of the vehicle 100. In such a large wire harness WH, some of the branch line modules 20 may have joint connectors and the like that are not actually used. In contrast, with the wire harness WH according to the present embodiment, the appropriate branch line module 20 that has only the necessary branch line side first connector 22 and branch line side second connector 23 can be connected. Therefore, the configuration of the branch line module 20 can be more simplified, thereby making it possible to suppress increase in the overall weight of the wire harness WH.

In general, as for a large wire harness WH with the trunk line module 10 with a bundle of various types of electric wires, it may be structurally difficult to employ, for the branch line module 20, the thin routing materials 21 with the allowable current value of about several mA. In contrast, in the present embodiment, the trunk line module 10 is configured with the flexible printed circuit board 11 that is thin in overall thickness and includes the fine wiring pattern 13. Therefore, it also has an advantage that it is easy to employ a structure for connecting the branch line module 20 configured with the thin routing materials 21 as specified in the above current range.

In general, the wire harnesses WH having the trunk line module 10 in which various electric wires are bundled is manufactured manually by workers. In contrast, since the flexible printed circuit board 11 can be manufactured by automation, it is possible by configuring the trunk line module 10 with the flexible printed circuit board 11 to reduce the man-hours for manufacturing the trunk line module 10, and thus to reduce the man-hours for manufacturing the wire harness WH.

Furthermore, in the present embodiment, the branch line module 20 is connected to the trunk line module 10 via the branch line side first connector 22, so that it can be attached to and removed from the trunk line module 10. Therefore, in the final step when manufacturing the wire harness WH, a worker simply needs to connect the branch line modules 20 prepared in advance to the trunk line module 10. For example, the worker can assemble the entire wire harness WH by attaching the trunk line module 10 before having the branch line modules 20 connected thereto on the structural member 111, and then connecting each of the branch line modules 20 to the trunk line module 10. In other words, it can also contribute to reducing the man-hours for designing the wire harness WH or facilitating the manufacturing work of the vehicle 100 that employs the wire harness WH.

Furthermore, with the trunk line module 10 and the wire harness WH according to the present embodiment, it is possible to replace the branch line module 20 alone for a single trunk line module 10. Therefore, when a trouble occurs in a certain branch line module 20, only that branch line module 20 can be easily replaced. In the meantime, by making the trunk line module 10 common and changing only a desired branch line module 20 as appropriate, various types of wire harnesses WH each having different types and lengths of branch line modules 20 can be easily formed. Furthermore, it is also possible to achieve an extension function as the so-called add-on, such as adding new functions to the wire harness WH after assembly, which are not set when assembled into the vehicle 100. When the trunk line module 10 configured with the flexible printed circuit board 11 is attached to the structural member 111, it may be attached via a protector that covers and protects the entire trunk line module 10.

Furthermore, since the branch line module 20 can be attached to and removed from the trunk line module 10, there is also an advantage that the trunk line module 10 and the branch line modules 20 can be individually managed under their own product numbers. For example, as a comparative example, when there are a plurality of general wire harnesses WH that differ from each other only in the length of a certain branch line module 20, each of the wire harnesses WH is managed with a separate product number applied thereto. In contrast, with the wire harness WH according to the present embodiment, the product number is applied for each of the branch line modules 20 in different lengths, while the common trunk line module 10 is managed with a single product number. Therefore, it is possible to easily increase the variation of changes in the branch line module 20 and to contribute to simplifying the management of man-hours associated with changes in the configuration of the wire harness WH.

In general, a large wire harness WH having the trunk line module 10 with a bundle of various types of electric wires is difficult to transport, due in part to the weight thereof. In contrast, with the wire harness WH according to the present embodiment, the trunk line module 10 and branch line modules 20 can be separately transported, which also has the advantage of, for example, reducing the number of days required for manufacturing the wire harness WH itself or the vehicle 100 that uses the wire harness WH, or reducing the limitation for the manufacturing location. Furthermore, with the wire harness WH according to the present embodiment, the branch line module 20 can be manufactured independently of the trunk line module 10, so it may be manufactured not by hand by a worker but by an automatic machine. In other words, with the wire harness WH according to the present embodiment, both the trunk line module 10 configured with the flexible printed circuit board 11 and the branch line modules 20 configured with the routing materials 21, that is, the entire wire harness WH, can be manufactured by an automatic machine. Therefore, it is advantageous for cost reduction, for example.

In addition, since the flexible printed circuit board 11 has flexibility in the present embodiment, the trunk line module 10 and the wire harness WH are easily adapted to various mounting parts in the vehicle 100. Furthermore, in the present embodiment, one or more trunk line side connectors 12 are installed at each of the first end parts 11a and second end parts 11b. Therefore, the trunk line module 10 can have the branch line modules 20 connected from opposite sides of each other. Therefore, when such a wire harness WH is installed in the vehicle 100, it is possible with the trunk line module 10 to increase the number of branch line modules 20 that can be connected and to increase the variations in the configuration of the wire harness WH.

As described above, in the wire harness WH according to the present invention, the flexible printed circuit board 11 is provided with the wiring pattern 13 that includes: a plurality of conductor circuit parts 13a that configure a transmission path by being electrically connected to each of the routing materials 21 via the trunk line side connector 12 and the branch line side first connector 22; and the joint part 13b that mutually connects at least two of the conductor circuit parts 13a. In the wire harness WH, such a configuration allows the configuration on the branch line module 20 side to be more simplified due to the joint part 13b provided on the trunk line module 10 side. In other words, the branching points in the entire wire harness WH can be concentrated at the joint parts 13b on the flexible printed circuit board 11. As a result, it is possible with the wire harness WH to improve assemblability to the vehicle 100 and the like.

Furthermore, in the wire harness WH according to the present embodiment, as for the branch line modules 20, all of the routing materials 21 configuring the first branch line module 20 extend without branching points from the branch line side first connector 22 provided at the terminals on one side to the branch line side second connector 23 provided at the terminals on the other side. The wire harness WH with such a configuration allows the configuration of the branch line modules 20 to be jointless, thereby making it possible to further improve the assemblability to the vehicle 100 and the like.

Furthermore, in the wire harness WH according to the present embodiment, the trunk line module 10 is connected to the ECU 30 via any one of the trunk line side connectors 12. In the wire harness WH, such a configuration allows the configuration on the ECU 30 side to be more simplified, which makes it possible to reduce the number of poles (wiring connectors) in the ECU 30 and trunk line side connectors 12 and to reduce the product number of the ECU 30.

Furthermore, in the wire harness WH according to the present embodiment, the trunk line module 10 is placed on the structural member 111 that is provided in the instrument panel 110 of the vehicle 100 and extends along the vehicle width direction Y. With such a configuration, for a relatively large wire harness WH that includes many branch line modules 20 corresponding to various devices such as a meter, air conditioner, audio equipment, and the like, it is possible with the wire harness WH to correspond to increase in the size of such a wire harness WH while suppressing increase in the overall weight of the wire harness WH.

While the embodiment of the present invention is described above, the embodiment is an example only and not intended to limit the scope of the present invention. The above embodiment can be implemented in various other forms, and various omissions, substitutions, combinations, and changes can be made without departing from the gist of the present invention. Furthermore, specifications such as each configuration, shape, and the like (structure, type, direction, form, size, length, width, thickness, height, number, arrangement, position, material, and the like) can be changed as appropriate.

In the wire harness according to the present embodiment, a flexible printed circuit board is provided with a wiring pattern that includes: a plurality of conductor circuit parts that configure a transmission path by being electrically connected to each of routing materials via a trunk line side connector and a branch line side first connector; and a joint part that mutually connects at least two of the conductor circuit parts. Such a configuration allows the wire harness to have more simplified configuration on the branch line module side due to the joint part provided on the trunk line module side. As a result, it is possible with the wire harness to improve the assemblability to vehicles and the like.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a trunk line module that includes a flexible printed circuit board exhibiting flexibility and a plurality of trunk line side connectors provided at an end part of the flexible printed circuit board; and
a plurality of branch line modules each including a plurality of routing materials exhibiting conductivity, and a branch line side first connector that is provided at terminals on one side of the routing materials, and mechanically and electrically connected to the trunk line side connector, wherein
the flexible printed circuit board includes a wiring pattern that includes: a plurality of conductor circuit parts that configure a transmission path by being electrically connected to each of the routing materials via the trunk line side connector and the branch line side first connector; and a joint part that mutually connects at least two of the conductor circuit parts, wherein
in each of the branch line modules, all of the routing materials configuring the branch line module extend without a branching point from the branch line side first connector provided at the terminals on one side to a branch line side second connector provided at terminals on other side, wherein
a plurality of the joint parts are provided in the wiring pattern, and the entire branching points including the trunk line module and the branch line modules are concentrated in the joint parts.

2. The wire harness according to claim 1, wherein the trunk line module is connected to an ECU via at least one of the trunk line side connectors.

3. The wire harness according to claim 1, wherein the trunk line module is placed on a structural member that is provided inside an instrument panel of a vehicle and extends along a vehicle width direction.

4. The wire harness according to claim 2, wherein the trunk line module is placed on a structural member that is provided inside an instrument panel of a vehicle and extends along a vehicle width direction.
